(19) United States
(12) Patent Application Publication
(10) Pub. No.: US 2026/0228404 A1
(43) Pub. Date: Aug. 6, 2026

(54) SYSTEM AND METHOD FOR SIMILARITY ANALYSIS OF NETLIST TOPOLOGY

(71) Applicant: Wistron Corporation, New Taipei City (TW)

(72) Inventor: Yu Ting Pan, New Taipei City (TW)

(73) Assignee: Wistron Corporation, New Taipei City (TW)

(21) Appl. No.: 19/056,548

(22) Filed: Feb. 18, 2025

(30) Foreign Application Priority Data
Feb. 4, 2025 (TW) 114104021

(51) Int. Cl. G06F 30/327

(52) U.S. Cl. CPC G06F 30/327

(57) ABSTRACT

A system and a method for similarity analysis of netlist topologies. The similarity analysis method includes following steps: obtaining netlist data, wherein the netlist data corresponds to a design of a printed circuit board (PCB); generating netlist topology data according to the netlist data; analyzing the netlist data based on the netlist data and reference PCB modules in a PCB module database using a learning algorithm, to calculate hit rates individually between the netlist data and the reference PCB modules; and, selecting at least one selected PCB module from the reference PCB modules based on the hit rates and the netlist topology data and providing the at least one selected PCB module to a layout user interface. The layout user interface presents the selected at least one PCB module on a user interface.

### CROSS-REFERENCE TO RELATED APPLICATION

This application claims the priority benefit of Taiwan application serial no. 114104021, filed on Feb. 4, 2025. The entirety of the above-mentioned patent application is hereby incorporated by reference herein and made a part of this specification.

### BACKGROUND

### Technical Field

The disclosure relates to a circuit design technology for a printed circuit board (PCB), and in particular relates to a system and a method for similarity analysis of netlist topologies.

### Description of Related Art

Contemporary electronic products are expected to have diversified functions while simultaneously striving to achieve higher standards in terms of size, performance, cost, energy efficiency, etc. Therefore, manufacturers seek to improve the design efficiency of electronic products and PCBs and shorten the development cycle. However, the functions of electronic products are becoming increasingly complex. Whenever a relocation of components is required, the circuits on the PCB necessitates redesign, a process which is not only time-consuming but also prone to errors.

On the other hand, the design of PCBs must also take into account multiple factors such as electromagnetic compatibility, thermal management, and signal integrity, thereby increasing the complexity of the design process. While it is desirable to modularize PCB design, such modular design relies on strict component nomenclature and identification standards. However, PCB designers may not necessarily adhere to these standards in their actual work, resulting in inefficient modular design and adversely affecting the overall design progress.

### SUMMARY

A system and a method for similarity analysis of netlist topologies, which may reduce the development time and cost required for PCB design by efficiently reusing printed circuit board (PCB) modules, are provided in the disclosure.

The similarity analysis method of a netlist topology of the embodiment of the disclosure includes the following operation. Netlist data is obtained, in which the netlist data corresponds to a design of a printed circuit board (PCB). Netlist topology data is generated according to the netlist data. The netlist data is analyzed based on the netlist data and reference PCB module in a PCB module database using a learning algorithm to calculate hit rates individually between the netlist data and the reference PCB modules. At least one selected PCB module is selected from the reference PCB modules according to the hit rates and the netlist topology data, and the at least one selected PCB module is provided to a layout user interface. The layout user interface presents the at least one selected PCB module on a user interface.

The netlist topology similarity analysis system of the embodiment of the disclosure includes a PCB module database and a processing host. The PCB module database includes multiple reference PCB modules. The processing host is coupled to the PCB module database. The processing host is configured to execute a similarity analysis assistant program and a layout user interface program. The layout user interface program obtains netlist data, in which the netlist data corresponds to a design of a printed circuit board (PCB). The similarity analysis assistant program is configured to execute the following operation. Netlist topology data is generated according to the netlist data. The netlist data is analyzed based on the netlist data and reference PCB module in a PCB module database through a learning algorithm to calculate hit rates individually between the netlist data and the reference PCB modules. At least one selected PCB module is selected from the reference PCB module according to the hit rates and the netlist topology data, and the at least one selected PCB module is provided to a layout user interface. The layout user interface presents the at least one selected PCB module on a user interface.

Based on the above, the embodiment of the disclosure determines whether various reference PCB modules stored in a PCB module database and current netlist data are similar by using a learning algorithm and a multi-dimensional evaluation standard, and selects a similar reference PCB module to be displayed in the placement environment of the layout user interface. In this way, when designing a PCB, a suitable reference PCB module may be quickly found to effectively reuse the reference PCB module in the PCB module database, thereby reducing the development time and cost required for designing the PCB. Furthermore, when designing a PCB, the learning algorithm and multi-dimensional evaluation standard of the embodiment of the disclosure may reduce the reliance on standard naming in component, pin and line data, and improve the accuracy in selecting a reference PCB module.

### BRIEF DESCRIPTION OF THE DRAWINGS

FIG. 1 is a block diagram of a similarity analysis system 100 for a netlist topology according to an embodiment of the disclosure.

FIG. 2 is a flow chart of a similarity analysis method of a netlist topology according to an embodiment of the disclosure.

FIG. 3 is a schematic diagram of netlist topology data generated according to netlist data according to an embodiment of the disclosure.

### DETAILED DESCRIPTION OF DISCLOSED EMBODIMENTS

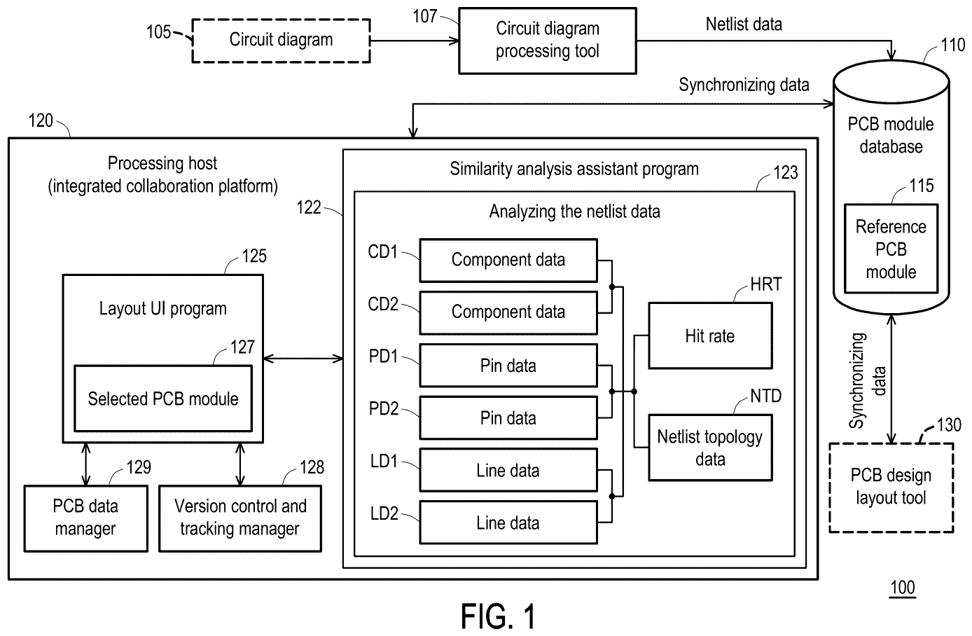

FIG. 1 is a block diagram of a similarity analysis system 100 for a netlist topology according to an embodiment of the disclosure. The similarity analysis system 100 mainly includes a printed circuit board (PCB) module database 110 and a processing host 120. The processing host 120 is coupled to the PCB module database 110. In other words, the processing host 120 and the PCB module database 110 may communicate and couple with each other through a network.

The PCB module database 110 may be set on a cloud server. The PCB module database 110 is mainly configured to store various types of PCB modules and their design data, and supports multi-user access. PCB designers may access PCB modules in the PCB module database 110 through the network at any time, and download and use them as needed. Therefore, the time cost of PCB designers in finding suitable PCB modules may be reduced.

The PCB module database 110 includes multiple reference PCB modules 115. The reference PCB module 115 of this embodiment may be PCB wiring data that is pre-built and applied to various functions. The single PCB module in this embodiment may be divided into multiple functional module blocks, for example, a central processing unit module, a high-definition multimedia interface (HDMI) module, a power supply module, a universal serial bus (USB) module, and other layout blocks. The similarity analysis system 100 of this embodiment presents a list of functional modules that must be designed within a single PCB module.

The processing host 120 may be disposed in a processor host (e.g., a desktop computer, a laptop, a tablet, etc.), a cloud server, etc. If the processing host 120 is set on a cloud server, the processing host 120 may be an integrated collaboration platform that allows multiple PCB designers to participate in the design of the same PCB and share the design progress and module resources in real time. These PCB designers may discuss and exchange opinions with each other on the integrated collaboration platform and view the modifications and suggestions of other PCB designers in real time. This may improve the overall design efficiency of PCB and reduce errors caused by poor communication. The processing host 120 and the PCB module database 110 automatically synchronize data with each other.

The processing host 120 is configured to execute a similarity analysis assistant program 122 and a layout user interface (UI) program 125. The similarity analysis assistant program 122 may use a learning algorithm (e.g., a machine learning algorithm or an artificial intelligence algorithm) such that the similarity analysis system 100 may automatically identify and classify the existing reference PCB module 115, and analyze the current netlist data according to the reference PCB module 115 and PCB design standards, thereby automatically and intelligently matching the current netlist data with these reference PCB modules 115, thus selecting a similar reference PCB module. Furthermore, the similar reference PCB module is displayed in the placement environment of the layout UI program 125. In this embodiment, the layout UI program 125 may be Allegro®, an electronic design automation (EDA) software used to design and develop PCBs.

The similarity analysis system 100 may further include a circuit diagram processing tool 107. The PCB designer may input the circuit diagram 105 into a circuit diagram processing tool 107. The circuit diagram processing tool 107 analyzes this circuit diagram and generates corresponding netlist data. That is, the PCB designer only needs to input the circuit diagram 105 as the design requirement, and the similarity analysis system 100 may provide the most suitable selected PCB module 127 from multiple reference PCB modules 115 and display it on the layout UI program 125. This significantly reduces the design time, increases the reuse rate of PCB modules, and reduces the workload of repeated design, thereby reducing development costs.

The similarity analysis system 100 may further include other PCB design layout tools 130. The function of the PCB design layout tool 130 of this embodiment may be the same as that of the processing host 120, and after the PCB design is completed, the PCB module with completed settings serves as one of the reference PCB modules 115 and uploaded to the PCB module database 110. In other words, the number of reference PCB modules 115 may be increased accordingly according to the number of completed PCB designs.

The similarity analysis assistant program 122 may analyze the netlist data (e.g., as indicated by reference numeral 123) by using a learning algorithm (e.g., a machine learning algorithm or an artificial intelligence algorithm). The multiple parameters in the netlist data and the multiple parameters respectively possessed by the multiple reference PCB modules 115 in the PCB module database 110 include component data, pin data and line data respectively.

Components, pins, and lines are closely interrelated. Components are the basic constituent parts of a circuit. Components are interconnected to the pins of other components through their pins through lines, collectively realizing the design and functionality of the circuit. For example, components usually refer to electronic parts such as resistors, capacitors, diodes, transistors, integrated circuits, etc. Each component has its own functions and characteristics. The component information may include a component name and corresponding pin names.

Each component includes multiple pins. These pins are the electrical connection points for the component. The number and function of pins vary depending on the type of component. For example, a resistor usually has two pins, while an integrated circuit may have dozens or even hundreds of pins. These pins are configured to make electrical connections to other components or pads in the circuit. The pin information may include the pin name.

The lines connect the pins of different components together through electrical connections to form a complete circuit structure. The pins of different components are connected together through lines so that signals may be transmitted in the circuit. Each line usually represents a specific signal path or voltage level. The line information includes the line name and the connection relationship between a line and a pin.

This embodiment integrates and analyzes the aforementioned component data, pin data, connection data, etc., as multi-dimensional evaluation indicators, thereby using a learning algorithm to determine the similarity between the netlist data and the reference PCB module.

For example, the netlist data includes component data CD1, pin data PD1 and line data LD1, and one of the reference PCB modules includes component data CD2, pin data PD2 and line data LD2. The similarity analysis assistant program 122 may integrate the netlist data with the component data CD1 and CD2, pin data PD1 and PD2, and connection data (line data) LD1 and LD2 of the reference PCB module into the netlist topology data NTD, and calculate the hit rate HRT between this netlist data and this reference PCB module by using the netlist topology data NTD, thereby reducing the reliance on standard naming and improving the accuracy of PCB module selection.

The similarity analysis system 100 may also include a version control and tracking manager 128. The version control and tracking manager 128 may record the historical changes made during each PCB design process, and allow the PCB designer to revert to previous PCB versions at any time. PCB designers may use the version control and tracking manager 128 to easily view the differences between different PCB versions and adjust the PCB design.

The similarity analysis system 100 may further include a PCB data manager 129. The PCB data manager 129 is, for example, a Gerber file manager. The Gerber file manager is a software tool configured to manage and process Gerber files. Gerber files are the file format used for PCB design. Gerber files may be configured to describe all the necessary information for each layer (e.g., copper layer, solder mask layer, logo layer, etc.) of the PCB and the manufacturing process. The Gerber file manager may be configured to manage, check, generate and view Gerber files.

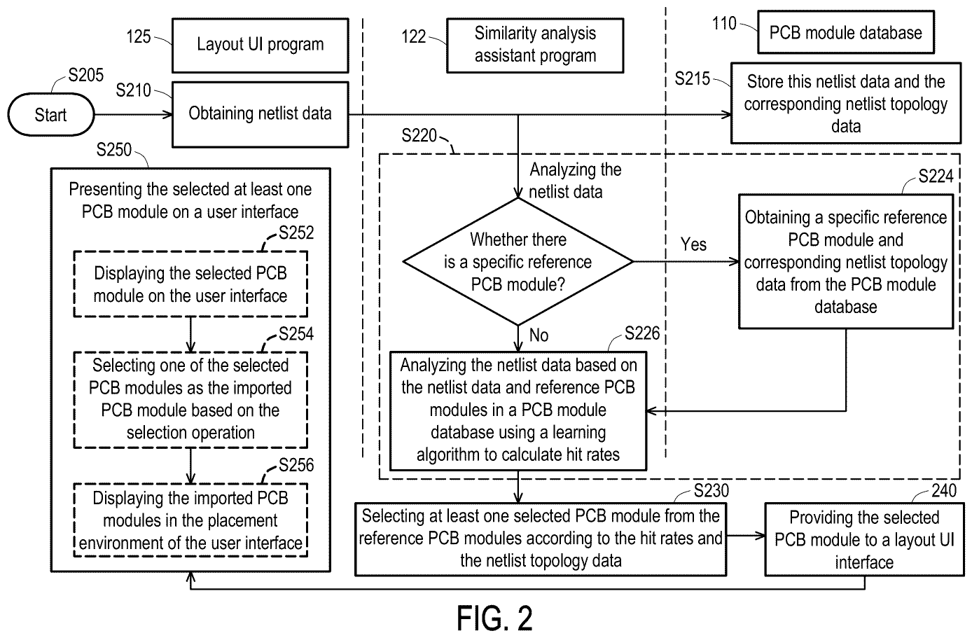

FIG. 2 is a flowchart of a similarity analysis method for a netlist topology according to an embodiment of the disclosure. Reference may be made to the similarity analysis system 100 in FIG. 1 for the hardware of the similarity analysis method in FIG. 2. Referring to FIG. 1 and FIG. 2 at the same time, in step S205, the similarity analysis method of the netlist topology is started. In step S210, the layout UI program 125 obtains netlist data. This netlist data corresponds to the design of the PCB. In step S215, the similarity analysis assistant program 122 transmits the netlist data and the corresponding netlist topology data to the PCB module database 110 for storage.

In step S220, the similarity analysis assistant program 122 analyzes the netlist data based on this netlist data and the multiple reference PCB modules 115 in the PCB module database 110 using a learning algorithm to calculate the hit rates individually between the netlist data and the reference PCB modules 115. In this embodiment, while calculating the hit rate, direct and indirect connections are made according to the component name and the component material number in the component data and through one of the pin names in the pin data, thereby connecting with other components to generate netlist topology data.

Specifically, in step S222, the similarity analysis assistant program 122 determines whether the netlist data includes information of a specific reference PCB module. The specific reference PCB module is one of the reference PCB modules 115 of FIG. 1. When the answer of step S222 is “yes”, the process proceeds to step S224, where the similarity analysis assistant program 122 obtains a specific reference PCB module and corresponding specific netlist topology data from the PCB module database 110, and proceeds from step S224 to step S226, where the similarity analysis assistant program 122 calculates the hit rate between this netlist data and the specific reference PCB module. Furthermore, the similarity analysis assistant program 122 calculates the hit rates between this netlist data and the reference PCB modules other than the specific reference PCB module, thereby determining whether there is a reference PCB module that is more similar to the netlist data.

When the answer of step S222 is “no”, the process proceeds to step S226, where the similarity analysis assistant program 122 analyzes the netlist data based on the netlist data and the reference PCB module 115 in the PCB module database using a learning algorithm to calculate the hit rate. The method for calculating the hit rate between the netlist data and the reference PCB module 115 is based on the results of a learning algorithm that compares the parameters of the netlist data and the parameters of the reference PCB module. The similarity analysis assistant program 122 may also generate the netlist topology data according to various parameters (e.g., component data, pin data, and line data) in the netlist data.

In step S230, the similarity analysis assistant program 122 selects at least one selected PCB module from the reference PCB modules 115 according to the hit rate and the netlist topology data in step S226. In this embodiment, the reference PCB modules 115 with the top three highest hit rate values may be selected as the selected PCB modules. The number of selected PCB modules may be adaptively adjusted according to the requirements of the user of this embodiment. In step S240, the similarity analysis assistant program 122 provides the selected PCB module to the layout UI interface 125 through the PCB module database 110.

In step S250, the layout UI interface 125 presents at least one selected PCB module on the user interface. Specifically, in step S252, the layout UI interface 125 displays the selected PCB modules (e.g., the selected PCB modules with the top three highest hit rate values) on the user interface. In other words, through the learning algorithm and multi-dimensional evaluation indicators, this embodiment performs similarity analysis and evaluation on the netlist data and each reference PCB module, thereby obtaining the top three reference PCB modules with the highest hit rate for recommendation. Each netlist data may be matched to a reference PCB module with a high hit rate for PCB design and adjustment.

In step S254, the layout UI interface 125 selects one of the selected PCB modules as the imported PCB module based on the selection operation. In step S256, the layout UI interface 125 displays the imported PCB module in the placement environment of the user interface.

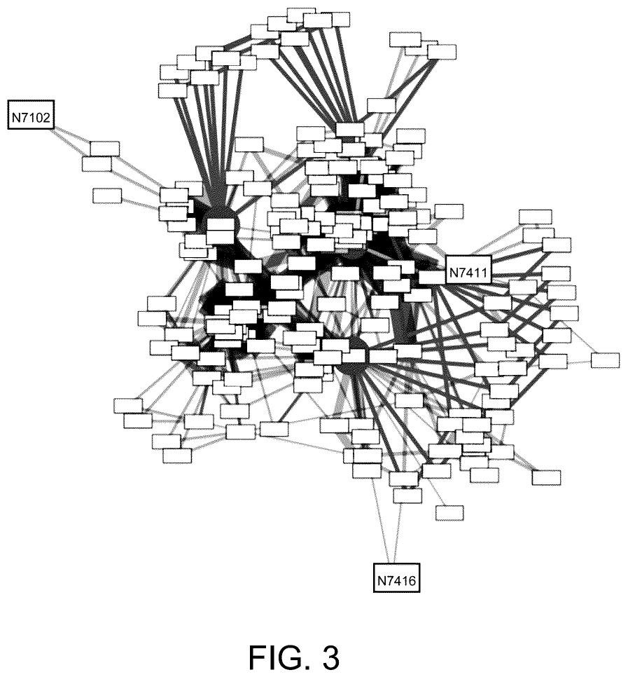

FIG. 3 is an exemplary schematic diagram of netlist topology data generated according to netlist data according to an embodiment of the disclosure. There are multiple endpoints in FIG. 3, such as endpoint N7102, endpoint N7416, endpoint N7411, etc. These endpoints may be one of the parameters of the netlist data and the parameters of the reference PCB module. For example, the endpoint N7102 may be one of the pin names of the netlist data; the endpoint N7102 may be one of the component names of this reference PCB module; the endpoint N7416 may be one of the line names of the netlist data, etc.

To sum up, the embodiment of the disclosure determines whether various reference PCB modules stored in a PCB module database and current netlist data are similar by using a learning algorithm and a multi-dimensional evaluation standard, and selects a similar reference PCB module to be displayed in the placement environment of the layout user interface. In this way, when designing a PCB, a suitable reference PCB module may be quickly found to effectively reuse the reference PCB module in the PCB module database, thereby reducing the development time and cost required for designing the PCB. Furthermore, when designing a PCB, the learning algorithm and multi-dimensional evaluation standard of the embodiment of the disclosure may reduce the reliance on standard naming in component, pin and line data, and improve the accuracy in selecting a reference PCB module.

What is claimed is:

1. A similarity analysis method of a netlist topology, comprising:
obtaining netlist data, wherein the netlist data corresponds to a design of a printed circuit board (PCB);
generating netlist topology data according to the netlist data;
analyzing the netlist data based on the netlist data and a plurality of reference PCB modules in a PCB module database using a learning algorithm to calculate hit rates individually between the netlist data and the reference PCB modules; and
selecting at least one selected PCB module from the reference PCB modules according to the hit rates and the netlist topology data, and providing the at least one selected PCB module to a layout user interface, wherein the layout user interface presents the at least one selected PCB module on a user interface.

2. The similarity analysis method according to claim 1, further comprising:
disposing the PCB module database, wherein the PCB module database comprises the reference PCB modules.

3. The similarity analysis method according to claim 2, further comprising:
storing the netlist data and the netlist topology data corresponding to the netlist data.

4. The similarity analysis method according to claim 2, wherein analyzing the netlist data based on the netlist data and the reference PCB modules in the PCB module database using the learning algorithm further comprises:
determining whether the netlist data comprises information of a specific reference PCB module, wherein the specific reference PCB module is one of the reference PCB modules;
obtaining the specific reference PCB module and corresponding specific netlist topology data from the PCB module database when the netlist data comprises the information of the specific reference PCB module; and
calculating the hit rate between the netlist data and the specific reference PCB module.

5. The similarity analysis method according to claim 2, wherein a plurality of parameters in the netlist data and a plurality of parameters of the reference PCB modules in the PCB module database respectively comprise component data, pin data, and line data,
wherein, calculating the hit rates between the netlist data and the reference PCB modules is based on results of comparing the parameters of the netlist data and the parameters of the reference PCB modules in the PCB module database.

6. The similarity analysis method according to claim 1, wherein presenting the at least one selected PCB module on the user interface comprises:
displaying the at least one selected PCB module on the user interface;
selecting one of the at least one selected PCB module as an imported PCB module based on a selection operation; and
displaying the imported PCB module in a placement environment of the user interface.

7. The similarity analysis method according to claim 1, wherein the learning algorithm comprises a machine learning algorithm or an artificial intelligence algorithm.

8. A similarity analysis system of a netlist topology, comprising:
a printed circuit board (PCB) module database, wherein the PCB module database comprises a plurality of reference PCB modules; and
a processing host, coupled to the PCB module database,
wherein the processing host is configured to execute a similarity analysis assistant program and a layout user interface program,
wherein the layout user interface program obtains netlist data, wherein the netlist data corresponds to a design of a PCB,
the similarity analysis assistant program is configured to execute:
generating netlist topology data according to the netlist data;
analyzing the netlist data based on the netlist data and the reference PCB modules in the PCB module database through a learning algorithm to calculate hit rates individually between the netlist data and the reference PCB modules; and
selecting at least one selected PCB module from the reference PCB modules according to the hit rates and the netlist topology data, and providing the at least one selected PCB module to a layout user interface,
wherein the layout user interface presents the at least one selected PCB module on a user interface.

9. The similarity analysis system according to claim 8, wherein the processing host and the PCB module database communicate with each other through a network, and the PCB module database is set on a cloud server.

10. The similarity analysis system according to claim 8, further comprising a PCB design layout tool, wherein the PCB design layout tool provides a PCB module with completed settings to the PCB module database, so that the PCB module with completed settings serves as one of the reference PCB modules.
